(19) United States
(12) Patent Application Publication
(10) Pub. No.: US 2025/0016577 A1
(43) Pub. Date: Jan. 9, 2025

(54) Highly Secure Wireless Network Discovery and Configuration System

(71) Applicant: Nova Labs, Inc., Las Vegas, NV (US)

(72) Inventors: Louis Thiery, Berkeley, CA (US); Joseph Padden, Boulder, CO (US); Andrew Thompson, Orrington, ME (US)

(73) Assignee: Nova Labs, Inc., Las Vegas, NV (US)

(21) Appl. No.: 18/825,399

(22) Filed: Sep. 5, 2024

Related U.S. Application Data
(60) Provisional application No. 63/524,980, filed on Jul. 5, 2023.

(51) Int. Cl. H04W 16/18; H04W 64/00

(52) U.S. Cl. CPC H04W 16/18; H04W 64/003

(57) ABSTRACT

The present disclosure provides a primary network mapper for mapping primary network assets in a primary network. The mapper includes a memory storing first reference network asset location data, a first reference transceiver for attachment to a first reference network, a primary transceiver for attachment to the primary network, a location processor for determining the mapper's location, a network metric processor for processing received network data to derive distance data, and a primary network asset location processor for determining the location of primary network assets by processing the mapper location data, reference network asset location data, and distance data. The mapper enables accurate mapping of primary network assets using data from multiple networks.

CROSS REFERENCE

The present application for patent claims the benefit of U.S. Provisional Patent Application No. 63/524,980, filed on Jul. 5, 2023, which is hereby incorporated by reference in its entirety.

### FIELD OF INVENTION

The present disclosure relates to wireless networks and, more particularly, to systems and methods for accurately mapping network assets in a secure manner. The disclosed systems and methods leverage multiple wireless technologies and data collection methods to provide comprehensive network mapping, thereby improving network planning, operation, and user experience.

### BACKGROUND

Wireless networks have become an integral part of modern communication infrastructure, enabling a wide range of applications from personal communication to industrial automation. These networks are typically composed of numerous network assets such as hotspots and access points that facilitate wireless communication. The accurate mapping and location of these network assets is a foundational aspect of network planning, operation, and maintenance.

However, the task of accurately mapping network assets presents several challenges. For instance, network assets like hotspots and access points are often difficult to initially locate at the time of installation. This is due to the fact that these assets are typically small, portable devices that can be installed in a variety of locations, ranging from indoor environments like homes and offices to outdoor environments like parks, city streets, home/business roof tops, and home/business balconies. The lack of a fixed installation location makes it difficult to accurately determine the initial location of these assets.

Moreover, the portable nature of these network assets means that they can be easily moved after installation, rendering their original location data inaccurate. This is particularly problematic for network planning and operation, as the location of network assets is a major factor in determining network coverage and performance. If a network asset is moved without updating its location data, it can lead to gaps in network coverage and degradation in network performance.

Furthermore, the task of updating the location data of network assets when they are moved is often a manual and time-consuming process. This process typically involves physically accessing the network asset, determining its new location, and updating the location data in the network management system. This manual process is not scalable for large networks with numerous assets, and it is prone to errors that can further degrade network performance.

In addition, the existing methods and systems for mapping network assets often rely on technologies like GPS for location determination. While GPS can provide accurate location data in outdoor environments, its performance can be severely degraded in indoor environments due to signal attenuation and multipath effects. This makes it difficult to accurately map network assets that are installed in indoor environments.

Therefore, there is a clear and pressing demand for improved systems and methods for mapping network assets that can overcome the aforementioned challenges. Such systems and methods would enable more accurate and efficient network planning and operation, leading to improved network performance and user experience.

### SUMMARY OF INVENTION

According to an aspect of the present disclosure, a system is provided for mapping a primary network. The system includes a memory storing data locating first reference network assets, a first reference wireless transceiver for communication with and attachment to a first reference wireless network, and a primary wireless transceiver for communication with and attachment to a primary wireless network. The system also includes a location processor for determining the location of the network mapper and generating network mapper location data. A network metric processor derives network data associated with the connection to one or both of the first reference network and the primary network. A primary network asset location processor determines the location of primary network assets by correlating the network mapper location data with the data locating first reference network assets utilizing the determined network data.

According to other aspects of the present disclosure, the system may include a hash generator for generating a hash of data derived from the multiple wireless transceivers. The multiple wireless transceivers may be selected from a group consisting of a 4G-LTE transceiver, 5GNR transceiver, a 6G transceiver, Bluetooth transceiver, Bluetooth low energy (BLE) transceiver, Wi-Fi transceiver, LoRa transceiver, an 802.11 transceiver, an 802.16 transceiver, and an Ultra Wideband transceiver. The system may also include a hash generator for generating a hash of the determined network data for the multiple wireless networks at the determined location of the network mapper. The location processor may utilize a Global Positioning System (GPS) to determine the location of the network mapper. The system may further include a third transceiver for scanning, communicating with, and attachment to a third wireless network.

In another aspect of the present disclosure, a method is provided for primary network asset location utilizing a network mapper having at least a first reference transceiver and a primary transceiver each utilizing different wireless protocol. The method includes scanning a wireless environment via the network mapper with the first and the primary wireless transceivers to identify first reference network attachment point and primary network attachment point and to generate wireless environment data. The method also includes attaching to the first reference network and primary network to create a wireless communication link, receiving first reference network data and primary network data associated with the first reference network and the primary network, and determining the location of the network mapper utilizing one or more location protocols. The method further includes processing one or more of the wireless environment data, the first reference network data, and the primary network data to determine wireless parameters characterizing each of the separate communication links, and processing the first reference network asset data locating first reference network assets, the wireless parameters, and the location of the network mapper to determine the location of primary network assets.

According to other aspects of the present disclosure, the method may include generating a hash of data derived from one or both of the first reference wireless transceivers and the primary wireless transceiver. The multiple wireless transceivers may be selected from a group consisting of a 4G-LTE transceiver, 5GNR transceiver, a 6G transceiver, Bluetooth transceiver, Bluetooth low energy (BLE) transceiver, Wi-Fi transceiver, LoRa transceiver, an 802.11 transceiver, an 802.16 transceiver, and an Ultra Wideband transceiver. The method may also include generating a hash of the wireless parameters. The location of the network mapper may be determined utilizing a Global Positioning System (GPS). The method may further include scanning via a third transceiver utilizing a third wireless protocol for communicating with and attachment to a third wireless network. The one or both of the first reference network data and the primary network data may be at least in part Call Data/Detail Record (CDR) data and/or Usage Data/Detail Record (UDR) data.

In other embodiments, the system may include a fourth transceiver for scanning, communicating with, and attachment to a fourth wireless reference network. The method may also include scanning via a fourth transceiver utilizing a known wireless protocol for communicating with and attachment to a fourth wireless network. Utilizing more reference networks can increase the accuracy of location primary network assets. Further, it will be understood that located primary assets may be utilized to determine the location of unlocated primary network assets.

### BRIEF DESCRIPTION OF FIGURES

Non-limiting and non-exhaustive examples are described with reference to the following figures.

FIG. 1A illustrates a block diagram of a system for secure wireless network discovery and configuration, in an embodiment.

FIG. 1B illustrates a flowchart for a mapping device process, in an embodiment.

FIG. 2 illustrates a system for secure wireless network mapping, in an embodiment.

FIG. 3 illustrates a method for a wireless network mapping system, in an embodiment.

FIG. 4 illustrates a block diagram of an SDX55 5G MiFi system, in an embodiment.

FIG. 5 illustrates a top view of a portable wireless device, in an embodiment.

FIG. 6A illustrates a sequence diagram for discovering locations of primary network assets, in an embodiment.

FIG. 6B illustrates another sequence diagram for discovering locations of primary network assets, in an embodiment.

FIG. 7 illustrates a method for refining and updating a primary network asset map, in an embodiment.

### DEFINITIONS

Hotspot: A portable device incorporating one or more wireless communication technologies, such as cellular (e.g., 5G), LoRa, CBRS, and Wi-Fi capabilities, designed for providing network connectivity in various environments.
Mapper: A portable hardware device containing several wireless technologies, used for one or more of network quality, coverage mapping, network threat detection, and ad-hoc mesh networking.
Trust Score: A score assigned to the location and information of a gateway, based on their continuous verification in the network.
Discovery Mapping: A process where a mobile operator's subscriber's discovery app or a dedicated mapper reports the user equipment “GPS location” periodically as the user/phone moves around the world for correlation with a seed cell list/map.
Discovery Mapping Event: Refers to a specific occurrence or instance during the discovery mapping process where a mapper device or user equipment performs one or more actions to collect and report data related to network discovery and mapping. These actions may include, but are not limited to, determining the device's GPS location, scanning for available wireless networks, attaching to one or more networks, receiving network data such as Call Data Records (CDRs), generating network metrics, and transmitting collected data to a central system for analysis and correlation with existing network asset information.
Scanning: Scans occur when your mapper passively “sniffs” the radio frequency environment to locate wireless coverage, e.g., Wi-Fi coverage, mobile operator coverage (e.g., 4G, 5G, 6G), CBRS coverage, Bluetooth coverage, and Helium network coverage. Scans may occur constantly, periodically, randomly, or may be event driven.
Attaching: When your UE or mapper has detected the network attachment device/cell (a Wi-Fi AP, a eNodeB, a gNodeB, a CBRS radio unit, etc.) it will begin to “attach” to the network attachment device for access to the network. By attaching the mapper may verify the coverage of the network attachment device, identity of the network asset and any associated assets, and determine the quality of coverage via, for example, the signal strength, RSSI, BER, modulation order, etc.
PLMN: The term Public Land Mobile Network (PLMN) refers to a network operated by a recognized mobile network operator. A PLMN may include various components such as base stations, mobile switching centers, and other network elements that provide mobile telecommunications services to subscribers within a specific geographical area. PLMNs may be identified by a unique combination of a Mobile Country Code (MCC) and Mobile Network Code (MNC), which together form the PLMN identity. In some aspects, multiple PLMNs may coexist within the same geographical area, allowing mobile devices to select and connect to different networks based on factors such as signal strength, roaming agreements, or user preferences.
Convex Hull: A convex hull is a polygon map element with shortest perimeter that encloses a set of points in a map data set.
Call Data Record (CDR): A record generated by a telecommunications network or device containing information about a specific communication transaction, such as call time, duration, source, destination, and other relevant details. An example of a CDR may include the cell ID of the tower a mobile device was connected to during a call, allowing network operators to track usage patterns and optimize network performance.
International Mobile Subscriber Identity (IMSI): A unique identifier assigned to each mobile network subscriber, typically stored in the SIM card. An example of an IMSI might look like “310150123456789”, where “310” is the mobile country code, “150” is the mobile network code, and “123456789” is the unique subscriber number.
Mobile Station International Subscriber Directory Number (MSISDN): The telephone number associated with a mobile subscriber's SIM card in a cellular network. An example of an MSISDN might be “+1 555-123-4567”, where “+1” is the country code, “555” is the area code, and “123-4567” is the local number.
Cell ID: A unique identifier for a specific cell tower or sector within a cellular network. An example of a Cell ID might be “12345”, representing a particular antenna on a specific tower in the network.
Serve_sid: Server System Identification number, used to identify a specific cellular carrier or network. An example of a serve_sid might be “4678”, representing a particular mobile network operator in a given region.
Mapper: A portable device equipped with multiple wireless technologies used for network discovery, quality assessment, and coverage mapping. An example of a mapper might contain 5G, Wi-Fi, and GPS modules to scan and report on various network parameters as it moves through an area.
Discovery Mapping: The process of collecting and reporting network data as a device moves through different locations. An example of perform discovery mapping by periodically recording and transmitting its GPS coordinates and detected cellular signal strengths.
Attaching: The process of establishing a connection to a specific wireless network. When a mobile device connects to a network, it goes through an attachment process to authenticate and register with the network.
Trust Score: A measure of reliability assigned to data or devices in a network mapping system. For example, a mapper device with consistent, accurate readings might be assigned a high trust score of 0.95 out of 1.0.

### DETAILED DESCRIPTION

The present disclosure relates to systems and methods for wireless network mapping and enhancing the security, accuracy, and adaptability of a wireless network. The system may include a mobile device, also referred to as a network mapper, equipped with multiple wireless transceivers. These transceivers may be capable of attaching to each associated network and receiving network specific data from each network during the attachment process or after attachment. Examples of network specific data are Call Data Records (CDRs) and Usage Detail Records (UDR). Network data, like CDR and/or UDR data, is important to the present systems and methods as it includes a “cell id” that uniquely identifies a network cell, cell towers, base station, network asset, hotspot, access point, etc. Some mobile operators also grouped these by serve_sid. A set of cell towers can be grouped and mapped utilizing serve_sid data, which can be shown to be contained by “convex hulls” formed by connecting the outer most geolocation data points that describe the location of each cell towers in the serve_sid set. CDR cell_id data may describe the “last” cell the user equipment or mapper was attached to. CDR data also includes subscriber identifying information, such as but not limited to IMSI data and MSISDN data. With this data the present systems and methods may correlate those with mapping events, for example, by correlating a closest “good” discovery mapping event (e.g., a UE/mapper GPS location) with one or more of cell_id data, serve_sid data, International Mobile Subscriber Identity (IMSI) data, and Mobile Station International Subscriber Directory Number (MSISDN) data transmitted in CDR data. Other types of data may include a history of cells or base stations the user equipment or mapper was attached to. The system may also include a location determination module that maps the location of the mobile device or mapper and primary network attachment points to generate CDR-primary network mapping data.

In addition, the system may include a network parameter module that determines network quality metrics for one or more reference networks (e.g., 5G networks, CBRS, networks, Wi-Fi networks, etc.) and the primary network (e.g., 5G networks, CBRS networks, Wi-Fi networks, LoRa network, etc.). A reference map or database may be used to correlate with the CDR-primary network mapping data to generate “coarse location” data for the primary network transceiver.

Furthermore, the system may include a trust or reliability engine that identifies trusted or reliable mappers. These trusted or reliable mappers may operate in the “coarse locations” to generate “fine location” data for the primary network assets. These assets may include, but are not limited to, access points, radio heads, radio units, base stations, small cells, gNodeBs, eNodeBs, xNodeBs (any future generation of NodeB).

The system and methods disclosed herein may provide enhanced security, accuracy, and adaptability of the wireless network by leveraging the capabilities of the mobile device or mapper, the location determination module, the network parameter module, the first reference network map or database, and the trust or reliability engine.

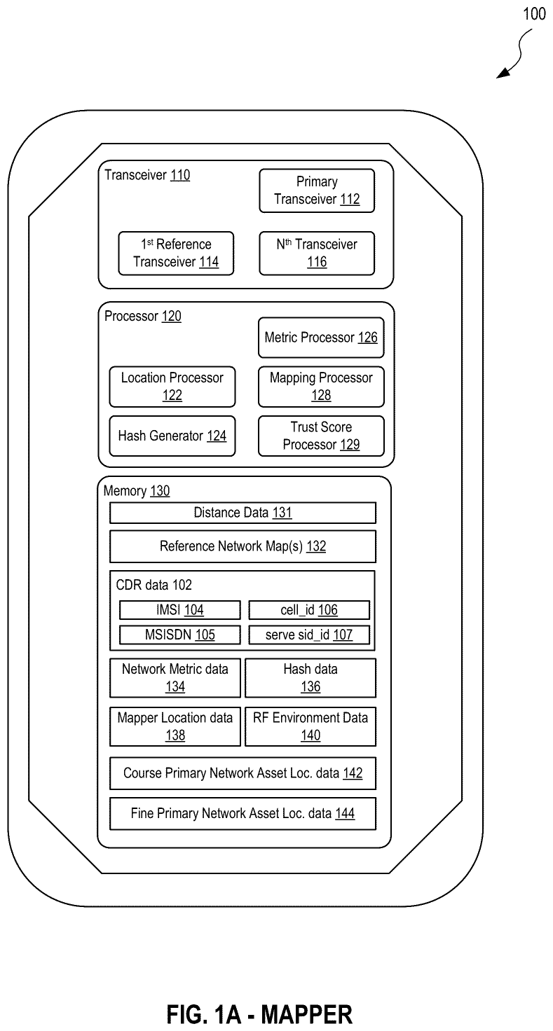

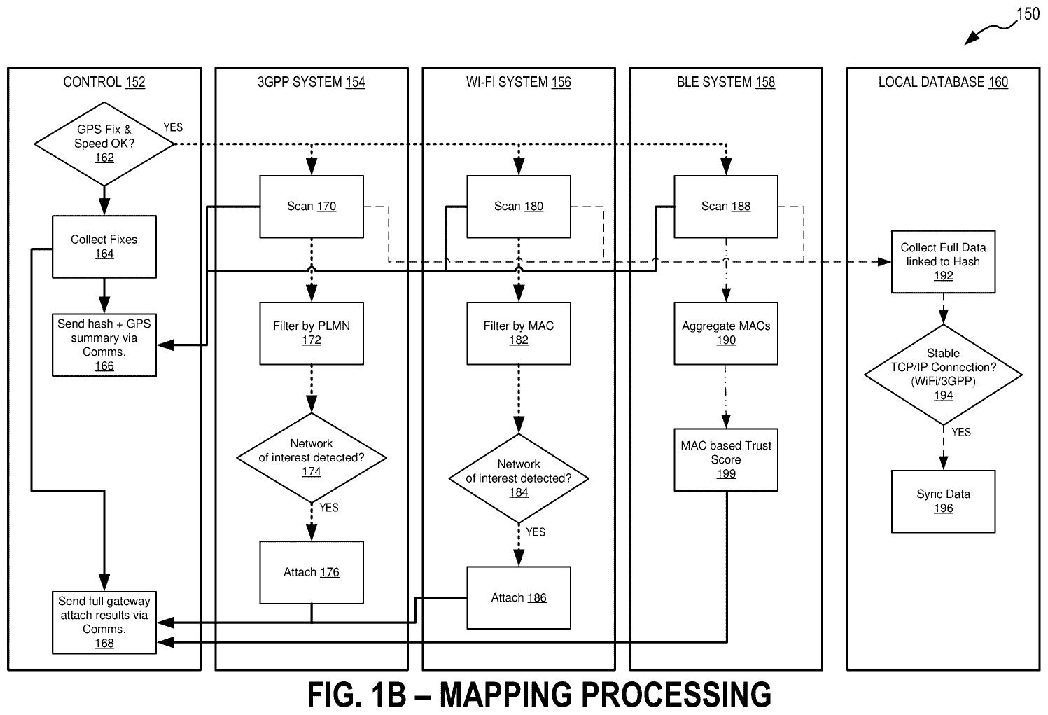

FIG. 1A shows a block diagram of a system for secure wireless network discovery and configuration, referred to as a mapper 100. The mapper 100 comprises several components organized into functional blocks.

In some aspects, the present disclosure provides systems and methods for network mapping and asset location, mapper 100, which utilizes a memory 130 to store various types of data. The memory 130 may include a reference network map 132, which may contain information about known reference network assets in one or more reference networks. This reference network map 132 may serve as a baseline for comparing and locating assets in the primary network. Data about known primary network assets may also be included here. The memory 130 may also store CDR data 102 (which may instead be UDR data), which may include several sub-elements of information. These sub-elements may include International Mobile Subscriber Identity (IMSI) 104, which may uniquely identify a mobile subscriber. The CDR data 102 may also include cell identification data 106, which may provide information about specific cell towers or base stations (also called network assets, amongst other names, herein), including a network asset's identity. A network asset's identity is used to geospatially locate a network asset via a cross reference to the reference network map(s) 132. Additionally, the CDR data 102 may contain Mobile Station International Subscriber Directory Number (MSISDN) 105, which may represent the telephone number associated with a mobile subscriber. The CDR data 102 may further include a server system identification number (serve sid id) 107, which may identify specific network servers, systems, or groups of network assets.

The memory 130 may also store network metric data 134, which may include various measurements and parameters related to reference and primary network performance and quality at various mapper 100 locations. This network metric data 134 may also be used to assess the health and efficiency of the mapped networks. In some implementations, the memory 130 may contain hash data 136, which may be generated from various inputs to ensure data integrity and security throughout the mapping process. Mapper location data 138 may also be stored in the memory 130, providing a record of the mapper's position during network scanning and data collection activities. This mapper location data 138 may be crucial for correlating collected network information with specific geographical locations.

Memory 130 also includes distance data 131 which stores within it a primary network mapper to first reference network asset (PNM-to-FRNA) distance data and primary network mapper to primary network assets (PNM-to-PNA) distance data, discussed further below.

Furthermore, the memory 130 may include RF environment data 140, which may contain information about the radio frequency characteristics of the scanned areas. This RF environment data 140 may be useful for understanding signal propagation and potential interference sources. In some aspects, the memory 130 may store two levels of network asset location data: course primary network asset location data 142 and fine primary network asset location data 144. These may represent different levels of precision in locating network assets in a primary network, allowing for both broad overview mapping and detailed, high-precision asset location when required.

The mapper 100 is equipped with a transceiver system 110, which is shown to include a first reference transceiver 114 and an Nth transceiver 116 for attachment to and communication with the first reference network and one or more Nth reference networks. First reference transceiver 114 and Nth reference transceiver 116 enables the mapper 100 to establish a communication link with the one or more reference networks and receive network-specific data.

Transceiver system 110 also includes a primary transceiver 112 for attachment to and communication with the primary network. This transceiver 112 allows the mapper 100 to establish a communication link with the primary network and receive network-specific data.

Mapper 100 also includes a processor system 120, which is shown to include a location processor 122. Location processor 122 determines the location of the mapper 100 and generates mapper location data for storage in the memory 130 as mapper location data 138. This location data 138 provides information about the geographical location of the mapper 100, which is crucial for mapping primary network assets.

Processor system 120 also is shown to include a network metric processor 126. This processor 126 processes received network metric data 132 associated with the attachment to one or both of the first reference network and the primary network to derive one or both of PNM-to-FRNA distance data and PNM-to-PNA distance data, stored in distance data 131. This data provides information about the distance between the mapper 100 and the network assets, which is essential for accurate network asset mapping. Distance data may also be the result of processing RF environment data 140.

Finally, processor system 120 includes a primary network asset location processor, mapping processor 128, for determining the location of one or more primary network assets by processing the mapper location data 138, the first reference network asset location data stored in reference network map(s) 132, the PNM-to-PNA distance data, and the PNM-to-FRNA distance data. This processor enables the mapper 100 to accurately locate primary network assets based on the collected and processed data.

The mapper 100 further includes a hash generator 124. The hash generator 124 is configured to generate a hash of data derived from one or more of the first reference transceiver 114, the Nth reference transceiver 116, the primary transceiver 112, the scanned environment, and any data storage in memory and transmitted to a remote location. The generated hash serves as a unique identifier for the data, ensuring its integrity and enabling the validation of the original data. This feature enhances the security of the network mapping process by preventing data tampering or corruption.

The location processor 122 in the mapper 100 is capable of determining the location of the mapper 100 using various location determination methods. In some cases, the location processor 122 may utilize a Global Positioning System (GPS) to determine the location of the network mapper. The GPS provides accurate geographical coordinates of the mapper 100, enabling precise location determination.

In other cases, the location processor 122 may utilize a trilateration process from one or both of known first network assets and known primary network assets to determine the location of the network mapper. Trilateration involves measuring the distances between the mapper 100 and known network assets to calculate the mapper's location. This method provides an alternative way of determining the location of the mapper 100 when GPS data is not available or reliable.

The mapper 100 also includes a trust score processor 129. The trust score processor 129 is configured to generate and attach a trust value to the determined one or more parameters for the multiple wireless networks at the determined location of one or both of the network mapper and primary network assets. The trust value serves as a measure of the reliability or accuracy of the determined parameters. This feature enhances the reliability of the network mapping process by providing a measure of confidence in the determined network parameters.

In some cases, the first reference transceiver 114 and the primary transceiver 112 may be the same transceiver. This configuration allows the mapper 100 to utilize a single transceiver for both the first reference network and the primary network, simplifying the hardware design and reducing the complexity of the system. This configuration may be particularly beneficial in scenarios where the first reference network and the primary network utilize the same wireless protocol, allowing the single transceiver to communicate effectively with both networks.

In other cases, the first reference transceiver 114 and the primary transceiver 112 may be different transceivers. This configuration allows the mapper 100 to utilize separate transceivers for the first reference network and the primary network, providing flexibility in terms of network compatibility and performance. For instance, the first reference transceiver 114 may be optimized for a specific wireless protocol used by the first reference network, while the primary transceiver 112 may be optimized for a different wireless protocol used by the primary network. Alternatively, the first reference transceiver 114 and the primary transceiver 112 may be used simultaneously to generate time-synched data generated at the same time stamp.

In some aspects, the first reference transceiver 114 and the primary transceiver 112 may utilize different wireless protocols. This configuration allows the mapper 100 to communicate with a variety of networks that utilize different wireless protocols, enhancing the versatility and adaptability of the system. For example, the first reference transceiver 114 may utilize a 4G-LTE (or a Wi-Fi) protocol for communication with the first reference network, while the primary transceiver 112 may utilize a 5G protocol for communication with the primary network.

The first reference transceiver 114 and the primary transceiver 112 may be selected from a group consisting of a 3G transceiver, a 4G transceiver, a 5G transceiver, a 6G transceiver, a Bluetooth transceiver, a Bluetooth low energy (BLE) transceiver, a Wi-Fi transceiver, a LoRa transceiver, an 802.11 transceiver, an 802.16 transceiver, a CBRS transceiver, and an Ultra Wideband transceiver. This wide range of transceiver options allows the mapper 100 to be compatible with a variety of wireless networks, enhancing its primary network mapping function in different network environments.

The network data received by the mapper 100 may be, for example, CDR data, UDR data, or similar depending on the wireless network and protocols used. CDR data is a record produced by a telecommunications network or a network device, which contains information about a telephone call or other telecommunications transaction that passes through the device or network. The CDR data includes information such as the time the call was started, the duration of the call, the completion status of the call, the source and destination of the call, and other transaction details. By processing the CDR data, the mapper 100 can gain valuable insights into the network traffic and usage patterns, which can be used to enhance the accuracy of the network mapping process and network needs, for example, network improvements.

In some cases, the mapper 100 receives one or more CDRs for at least one of the networks it is attached to. The received CDRs provide detailed information about the network transactions, which can be used to analyze the network identity and performance, which may be utilized to identify potential issues or areas for improvement. The CDRs can also be used to verify the integrity of the network data and ensure that the network mapping process is based on accurate and reliable data.

FIG. 1B illustrates a flowchart for a mapping process 150, focusing on the scanning, attachment, and data collection steps performed by a control 152, a 3GPP system 154, a Wi-Fi system 156, and a BLE system 158, utilizing a local database 160.

The process 150 begins with a decision step 162 in the control 152, which checks if the GPS fix and speed are acceptable. If No, the process 150 moves to step 164 where process 150 collects GPS and speed fixes. The control 152 then sends a hash and location/speed summary to a remote storage and or processing system via a send hash and location summary step 166.

If the GPS fix and speed are acceptable in step 162 then process 150 moves to scanning steps 170, 180, and 188 in the 3GPP system 154, Wi-Fi system 156, and BLE system 158, respectively. The 3GPP system 154 executes a 3GPP scan step 170 scanning the RF environment and locating any 3GPP network assets to retrieve any PLMN data, which is followed by a filter step 172 to filter for PLMN data. A decision step 174 checks the PLMN filtered data to determine if a network of interest is detected. An example of a network of interest is a network that corresponds to a known reference network or the primary network, e.g., identified by PLMN data. If yes, a 3GPP attachment step 176 is performed and network data, such as CDR data, is acquired.

Similarly, the Wi-Fi system 156 performs a Wi-Fi scan step 180 scanning the RF environment and locating any Wi-Fi network assets to retrieve any MAC address data, which is followed by a MAC address filter step 182. A decision step 184 checks the MAC address filtered data to determine if a network of interest is detected. An example of a network of interest is a network that corresponds to a known reference network or the primary network, e.g., identified by MAC address. If detected, a Wi-Fi attachment step 186 is executed, and network data is acquired.

The Bluetooth (BLE) system 158 conducts a Bluetooth scan step 188 to identify Bluetooth devices in proximity to mapper 150/100, followed by an aggregate MACs step 190 which aggregates the Bluetooth MAC address for processing in step 199. In processing step 199, Bluetooth MAC addresses in proximity of mapper 150/100 are processed and compared to known Bluetooth devices previously associated with the mapper 100/150 to determine or augment a trust score of the mapper 150/100. The goal is to ensure a mapper is not being spoofed and/or can be trusted and this can be determined by knowing the mapper is situated where or with devices that it has been situated previously and/or consistently. A similar process can be used with other wireless devices, such as Wi-Fi devices and for example, indoor 5G base stations such as picocell. Step 199 may be performed locally on mapper 150/100 or may be performed remotely. Step 199 then proceeds to step 168.

The local database 160 collects full data linked to the hash in a data collection step 192. A decision step 194 checks for a stable connection, for example a TCP/IP connection. If present, a synch step 196 is performed, sending data to the remote storage and or processing system.

The control 152 also includes a send full gateway attach results step 168, which receives input from the 3GPP and Wi-Fi attachment steps.

This process 150 demonstrates a multi-system approach to wireless network mapping, incorporating various wireless technologies and data collection methods.

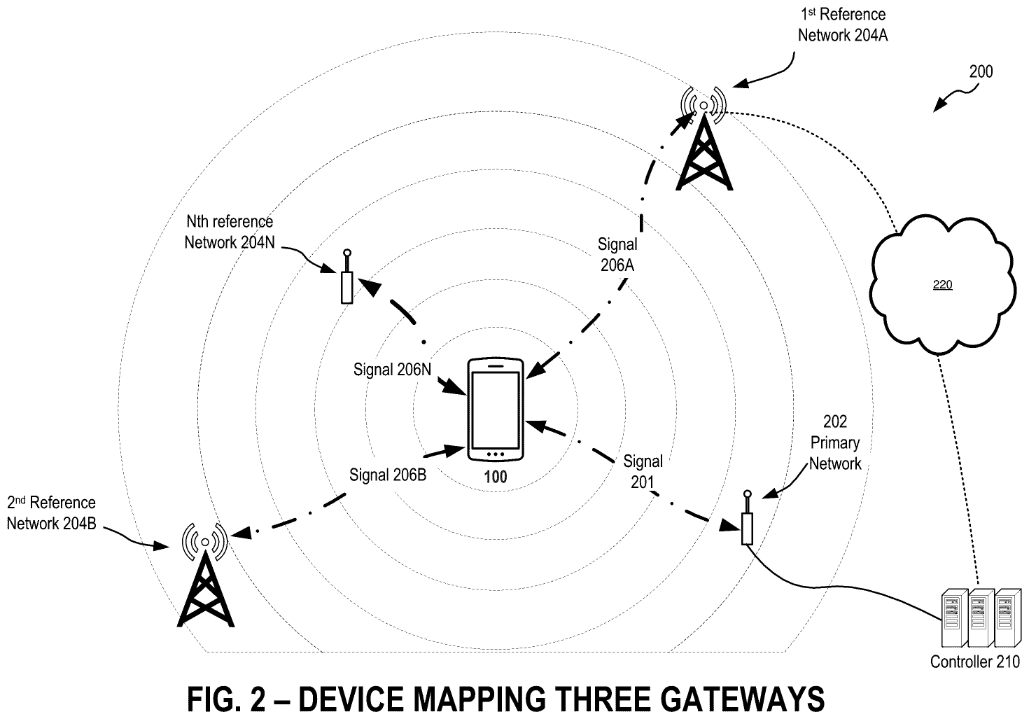

FIG. 2 shows a wireless environment 200 for secure wireless network mapping.

The environment 200 comprises a mapper 100, which is capable of communicating with multiple gateways (also called herein network assets), such as a first reference asset/gateway 204A, a second reference asset/gateway 204B, an Nth reference asset/gateway 204N, and a primary network 202. These gateways represent multiple gateways that can be present in the network. The mapper 100 communicates with each gateway through separate signal paths, such as a signal 201, a first signal path 206A, a second signal path 206B, and an Nth signal path 206N. These signal paths allow for the exchange of data and information necessary for network mapping.

In some aspects, the mapper 100 is equipped with multiple transceivers, such as a first reference transceiver 114, Nth transceiver 116, and a primary transceiver 112, which enable it to communicate with various wireless networks, such as 1st reference network 204A, second reference network 204B, Nth reference network 204N, and primary network 202. The mapper 100 may attach to these networks and receive network-specific data, such as CDRs or its equivalent depending on the protocol used, from each network during the attachment process.

The mapper 100 may also determine its location using various location determination methods, such as GPS, triangulation or trilateration from known network assets, or a combination thereof. The determined location of the mapper 100, along with the received network-specific data, can be used to map the primary network and locate primary network assets, such as primary network 202 asset.

In some cases, the mapper 100 may also generate a hash of the received network-specific data. The generated hash serves as a unique identifier for the data, ensuring its integrity and enabling the validation of the original data sent to, for example, a controller 210. Data may be sent to controller 210 via primary network 202 or may sent by another path, for example via 1st reference network 204A then over internet 202. Controller 210 may be or may cooperate with controller 152, FIG. 1B. This feature enhances the security of the network mapping process by preventing data tampering or corruption. It will also be understood that located wired/access network asset, such as but not limited to a DOCSIS network, a DSL network, and fiber-to-the-home network, etc. may be utilized as a or as part of a reference network. For example, one or more Wi-Fi access points or 5G picocells connected to a location identified DOCSIS network, e.g., via a subscriber address, may be utilized as a reference network. Alternatively, mapper 150/100 may be wire connected to a located access network, for example via an ethernet or USB cable connections.

The environment 200 demonstrates the capability of the mapper 100 to interact with and attached to multiple gateways, such as primary network assets 202 and reference network assets 204A-N simultaneously, potentially enabling comprehensive network mapping across various types of wireless infrastructure. By leveraging connections to and data derived from the primary network, understanding of the wireless environment, and connections to and data derived from wireless reference network assets with known asset locations, the present systems and methods can locate primary network assets.

Network asset location plays a crucial role in the effective deployment, management, and optimization of wireless networks. In some aspects, accurate location data may be essential for network planning, allowing operators to strategically place access points to maximize coverage and capacity. For instance, in networks like a Helium network, location-based reward systems may be implemented to incentivize the deployment of access points in areas with higher demand, potentially through location boosting mechanisms that increase rewards for strategically important locations. However, the importance of accurate location data also highlights the need for robust verification methods, as fraudulent activities such as location spoofing or duplicating base station identities may compromise network integrity and fairness in reward distribution. Furthermore, network access point locations may change over time due to various factors such as equipment upgrades, environmental changes, or user relocations. Keeping track of these changes may be vital for maintaining an up-to-date network map, which in turn may support efficient network management, troubleshooting, and performance optimization. Accurate location data may also be instrumental in regulatory compliance, ensuring that network deployments adhere to local zoning laws and spectrum usage regulations. Additionally, precise asset location information may enhance network security by helping identify unauthorized or rogue access points, and may improve emergency services by enabling more accurate location-based responses. As wireless networks continue to evolve and expand, the ability to accurately locate and map network assets may become increasingly important for ensuring reliable, efficient, and secure communications.

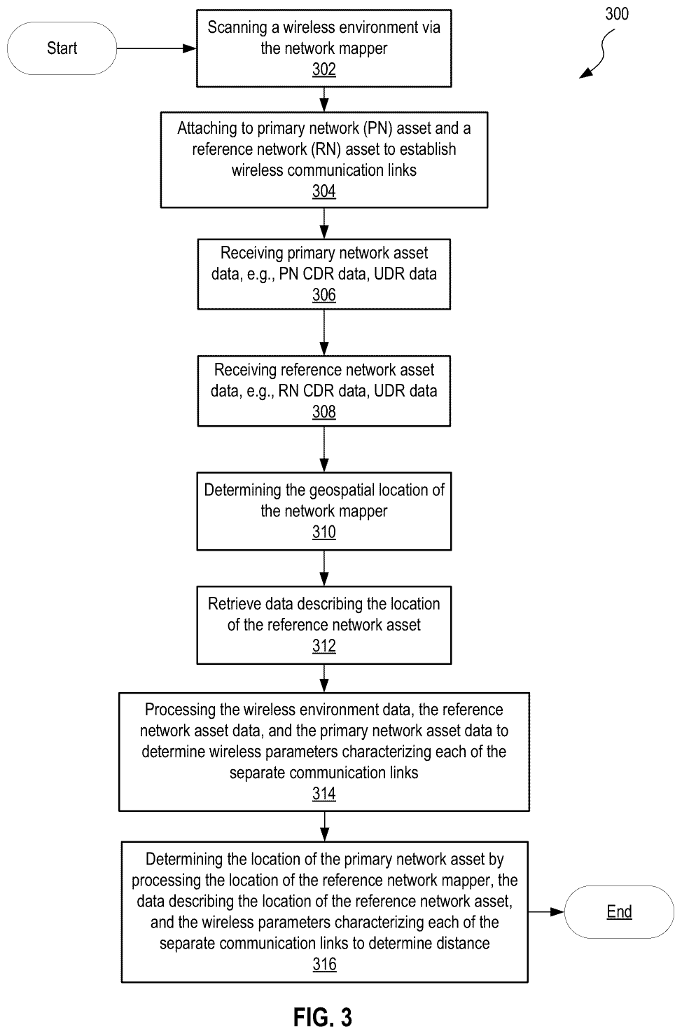

FIG. 3 shows a method 300 of secure wireless network discovery and configuration. In one example, method 300 may be implemented by mapper 100 using process 150 in environment 200.

The method 300 begins with a scanning step 302, where a wireless environment is scanned via a network mapper, such as mapper 100. The scanning step 302 involves the mapper 100 utilizing its multiple wireless technologies to sense the environment and detect various wireless networks. These networks may include, but are not limited to, 3G, 4G, 5G, 6G, Bluetooth, Bluetooth low energy (BLE), Wi-Fi, LoRa, 802.11, 802.16, CBRS, and Ultra Wideband networks. The scanning step 302 provides a comprehensive overview of the wireless environment, enabling the mapper 100 to identify the available networks and their respective characteristics. Scanning the network environment may also provide data describing the radio frequency environment, including features that absorb or reflect RF, which can have an impact on a determined RF distance, e.g., rendering an RF distance longer than a spatial distance due to reflections and/or absorptions.

Following the scanning step 302, the method 300 proceeds to an attaching step 304. In this step, the mapper 100 attaches to a primary network asset and a reference network asset to establish wireless communication links. The attachment process involves the mapper 100 utilizing its multiple transceivers to establish connections with the detected networks. The mapper 100 may attach to each network individually. or it may attach to multiple networks simultaneously, depending on the capabilities and number of its transceivers and the requirements of the networks. The attaching step 304 enables the mapper 100 to establish direct communication links with the networks, thereby enhancing the accuracy and reliability of the network mapping process.

Upon completion of the attaching step 304, the method 300 moves to a primary network data step 306. In this step, the mapper 100 receives primary network (PN) asset data, such as PN CDR/UDR data. This data provides detailed information about the primary network, for example, one or more of the identities of the network assets, the quality of the network connections, and other relevant information. The primary network data step 306 enhances the comprehensiveness of the network mapping process by providing detailed information about the primary network.

Following the primary network data step 306, the method 300 proceeds to a reference network data step 308. In this step, the mapper 100 receives reference network (RN) asset data, such as RN CDR/UDR data. This data provides detailed information about the reference network, such as one or more of the identities of the network assets, the quality of the network connections, and other relevant information. The reference network data step 308 enhances the comprehensiveness of the network mapping process by providing detailed information about the reference network.

The method 300 then proceeds to a location step 310. In this step, the mapper 100 determines its geospatial location. The location determination process may involve the mapper 100 utilizing one or more location determination methods, such as GPS, triangulation, and/or trilateration. The location step 310 provides accurate location data for the mapper 100, thereby enhancing the accuracy of the network mapping process.

Following the location step 310, the method 300 moves to a reference network asset location step 312. In this step, the mapper 100 retrieves data describing the location of reference network asset identified in step 308. This data may be retrieved from a reference network map or database, which contains information about the known locations of the reference network assets. The reference network asset location step 312 enhances the accuracy of the network mapping process by providing accurate location data for the reference network assets.

The method 300 then proceeds to a characterize communication links step 314. In this step, the mapper 100 processes the primary network asset data, the reference network asset data, and the wireless environment data to determine wireless parameters characterizing each of the separate communication links. These parameters may include, but are not limited to, signal strength, signal quality, signal-to-noise ratio, and other relevant metrics. The characterize communication links step 314 enhances the accuracy of the network mapping process by providing detailed information about the characteristics of the communication links. This data can be used to determine a distance of the mapper 100 from each network asset it is attached to, for example, this data may be used to derive one or both of PNM-to-FRNA distance data and PNM-to-PNA distance data.

Finally, the method 300 concludes with a locate primary asset step 316. In this step, the mapper 100 determines the location of the primary network asset by processing the mapper location data, the reference network asset location data, the primary network asset data, and the wireless parameters characterizing each of the separate communication links (e.g., the PNM-to-FRNA distance data and PNM-to-PNA distance data). The locate primary asset step 316 provides accurate location data for the primary network assets, thereby enhancing the accuracy and reliability of the network mapping process.

In some aspects, the method 300 may be implemented in a cloud environment, allowing for efficient processing of large amounts of data and providing scalability to accommodate large networks. The cloud environment may also provide robust data storage and backup capabilities, enhancing the reliability of the network mapping process.

In other cases, the method 300 may be implemented at a primary network processing environment. This configuration allows for localized processing of data, which can reduce network latency and improve the responsiveness of the network mapping process. The primary network processing environment may also provide enhanced security features, such as data encryption and access control, to protect the network data from unauthorized access or tampering.

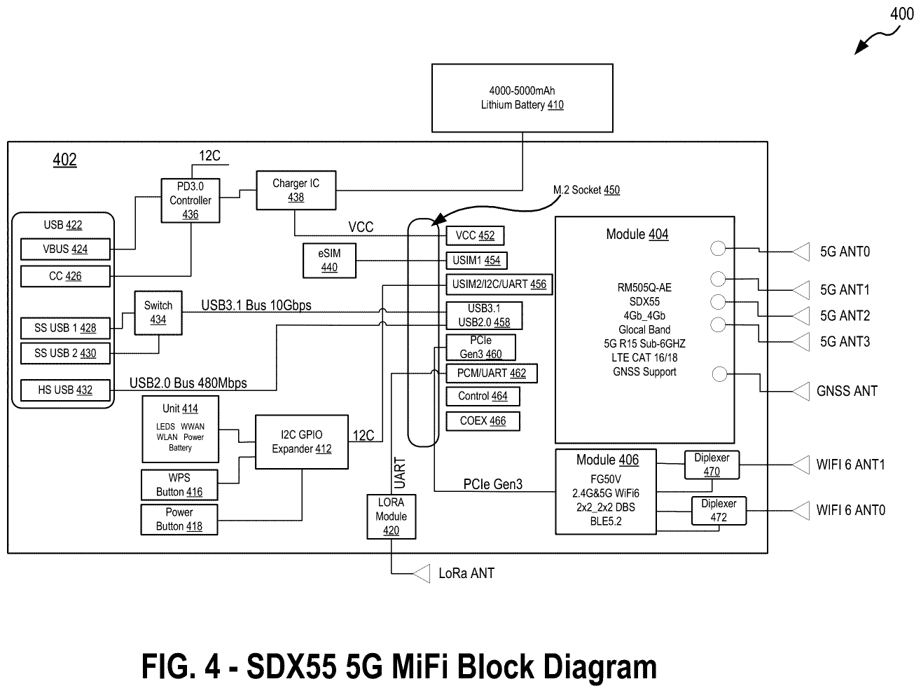

Referring to FIG. 4—SDX55 5G MiFi Block Diagram, the SDX55 5G MiFi system 400 is equipped with multiple transceivers, antennas, and connectivity modules, which enable versatile network mapping and communication across various wireless protocols attached or connected to a circuit board 402.

The system 400 includes a Wireless_1 module 404 and a Wireless_2 module 406, which handle wireless communications. The Wireless_1 module 404 is equipped with multiple antennas for signal reception and transmission. These antennas may include, but are not limited to, 5G antennas ANT0-ANT3 for 5G communication, GNSS antennas GNSS ANT for location services and may utilize 4G/LTE antennas (not shown). The Wireless_2 module 406 features two antennas, WiFi 6 ANT0 and ANT1, connected by diplexers 470, 472 to support Wi-Fi capabilities and may be configured with Bluetooth functionality, e.g., BLE5.2.

The system 400 is powered by a battery 410, providing portability. A LoRa module 420 is incorporated for wireless communication, with a LoRa antenna, shown as LoRa ANT, for signal transmission and reception. The system utilizes an I2C GPIO expander 412 for additional input/output capabilities. Expander 412 is connected to a unit 414, which may serve as an interface or control unit for various components such as LEDs, WWAN, WLAN, etc. Expander 412 is also connected to a WPS button 416, potentially allowing for easy Wi-Fi Protected Setup connections, and a power button 418 for user control of the device's power state.

A USB unit 422 is provided for external connections, with a VBUS 424 and a CC 426 for power and communication respectively. A charger IC 438, which manages battery 410 charging and provides power to VCC 452, is controlled by PD3.0 controller 436, which itself is in communication with CC426 and VBUS 424. An eSIM 440 is included for cellular connectivity.

USB unit 422 provides a physical interface for connecting the system 400 to external devices, such as computers, servers, or other network devices. This feature enhances the versatility of the system 400, allowing it to exchange data with a wide range of devices and networks. In some aspects, the USB unit 422 may support various USB standards, including HS USB 432, SS USB 1 428, and SS USB 2 430. These standards provide different levels of data transfer speeds and power delivery capabilities, enabling the system 400 to adapt to the requirements of the connected devices and networks.

The VCC 452 distributes power throughout the system. Control logic 464 manages the operation and coordination of the various components.

Continuing with the description of the SDX55 5G MiFi system 400, battery 410 may be but not limited to a lithium battery, for powering the system. The battery 410 provides a portable power source for the system 400, enabling it to operate independently of external power sources. This feature enhances the portability of the system 400, allowing it to be used in various locations and environments for network mapping and communication.

The system 400 also includes a PCIe Gen3 460 interface for data transfer. The PCIe Gen3 460 interface provides a high-speed data transfer channel for the system 400, enabling it to exchange large amounts of data quickly and efficiently. This feature enhances the performance of the system 400, particularly in scenarios that require high-speed data communication, such as network mapping and communication.

System 400 includes control logic 464 for managing the operation and coordination of the various components. The control logic 464 oversees the operation of the system 400, coordinating the activities of the various components and ensuring that they work together effectively. This feature enhances the overall functionality and efficiency of the system 400, enabling it to perform network mapping and communication tasks effectively and reliably.

A USB switch 434 is present in the system, which may be used for routing signals between SS USB 1 428/SS USB 2 430 and USB3.1 USB2.0 458. HS USB 432 also connects with USB3.1 USB2.0 458. M.2 Socket 450 provides a connection interface for modules, allowing for easy installation or replacement of, for example, cellular modem.

USIM1 454 and USIM2/I2C/UART 456 represent SIM card interfaces and additional communication protocols, enabling cellular connectivity and data transfer. The USB3.1/USB2.0 458 interface allows for high-speed data transfer and connectivity with external devices.

PCM/UART 462 may provide pulse-code modulation and universal asynchronous receiver-transmitter capabilities, enabling audio processing and serial communication respectively.

Control logic 464 manages the operation and coordination of the various components within the system, ensuring proper functionality and communication between different modules. Finally, COEX 466 may represent a coexistence interface, which helps manage potential interference between different wireless technologies operating simultaneously within the device.

These components work together to create a comprehensive 5G MiFi system 400 capable of providing high-speed wireless connectivity across multiple protocols and standards.

In a software embodiment, system 400 may be implemented in a user's mobile device, leveraging the mobile device's hardware augmented with software functionality. This configuration allows the system 400 to take advantage of the existing hardware resources of the mobile device, while adding additional functionality through software. This approach enhances the versatility of the system 400, allowing it to be used in a wide range of devices and environments for network mapping and communication.

This block diagram represents the internal architecture of the SDX55 5G MiFi system 400, showcasing the integration of various wireless technologies and supporting components in a compact form factor. The system 400 is capable of scanning the wireless environment, attaching to various networks, and receiving network-specific data from each network during the attachment process or after attachment. An example of network-specific data is CDRs and or UDRs, which may include a “cell id” that uniquely identifies a network cell, base station, access point, etc.

In some aspects, the system 400 may include additional transceivers for scanning, attachment to, and communication with additional wireless network. These transceiver allow the system 400 to establish a communication link with additional reference and or primary networks and to receive network-specific data. These additional transceivers enhances the versatility of the system 400 by enabling it to communicate with multiple networks, thereby improving the accuracy and comprehensiveness of the network mapping process and for mapping additional primary network assets of the same or different protocols.

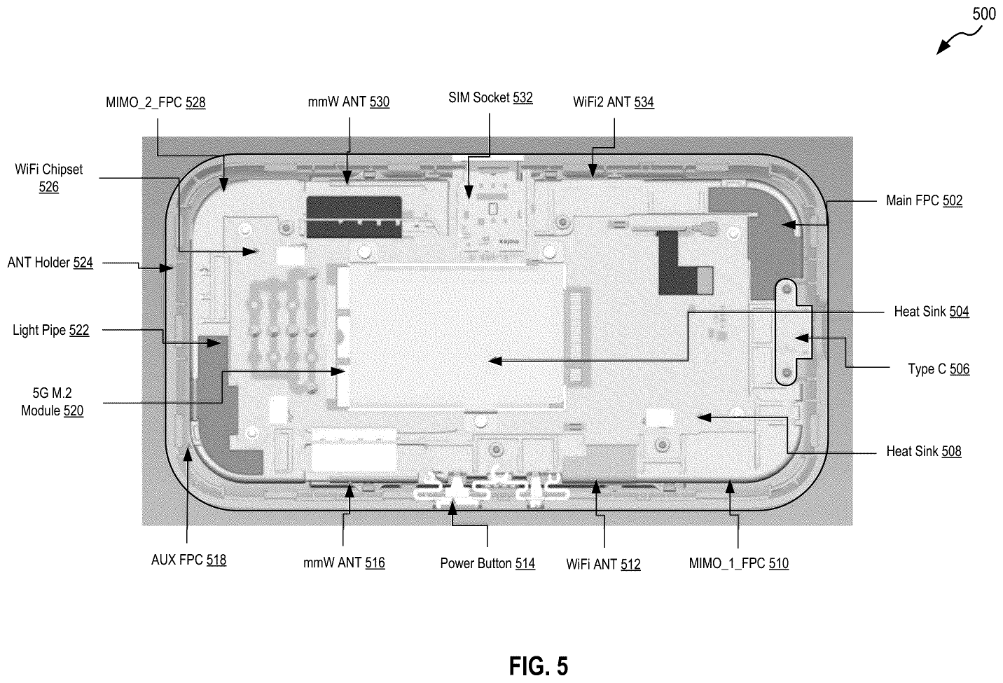

Referring to FIG. 5, the figure illustrates a top view of a portable wireless device 500, also referred to as a mapper and is similar to mapper 100, 400.

Mapper 500 is formed on a flexible printed circuit (FPC) 502 and an auxiliary FPC 518. Mapper 500 is equipped with multiple antennas for various wireless technologies, some or all held by antenna holder 524. These antennas include a WiFi antenna (ANT) 512, a mmW ANT 516, a mmW ANT 530, a WiFi2 ANT 534, and a LoRa antenna (not shown for sake of clarity and simplicity in FIG. 5). These antennas enable the mapper 500 to receive and transmit signals across various wireless networks, enhancing its network mapping capabilities.

In some aspects, the mapper 500 includes MIMO (Multiple-Input Multiple-Output) capabilities, with MIMO_1 FPC 510 and MIMO_2 FPC 528 positioned at opposite ends of the device. MIMO technology allows the mapper 500 to transmit and receive more than one data signal simultaneously over the same radio channel, thereby improving the speed and efficiency of data transmission. MIMO capabilities also provide angle of arrival functionality to the device further enhancing triangulation capabilities.

The mapper 500 also includes a 5G M.2 module 520 centrally located within the device. The 5G M.2 module 520 provides 5G connectivity capabilities, enabling the mapper 500 to communicate with 5G networks. This feature enhances the versatility of the mapper 500, allowing it to operate effectively in various network environments.

Adjacent to the 5G M.2 module 520 is a WiFi chipset 526, responsible for WiFi communications. The WiFi chipset 526 enables the mapper 500 to establish a WiFi connection, allowing it to communicate with WiFi networks. This feature enhances the network mapping capabilities of the mapper 500 by enabling it to map WiFi networks in addition to other types of wireless networks.

The mapper 500 incorporates a type C connector 506 for charging and data transfer. The type C connector 506 provides a physical interface for connecting the mapper 500 to external devices, such as computers, servers, or other network devices. This feature enhances the versatility of the mapper 500, allowing it to exchange data with a wide range of devices and networks.

In some cases, the mapper 500 may include additional components and features to enhance its network mapping capabilities. For example, the mapper 500 may include a GPS module (not shown in FIG. 5) for location determination, a battery similar to battery 410 (not shown in FIG. 5) for power supply, and various sensors (not shown in FIG. 5) for environmental sensing. These additional components and features enhance the functionality of the mapper 500, enabling it to perform comprehensive network mapping tasks in various environments and conditions.

Continuing with the description of the portable wireless device 500, the device includes heat sinks 504 and 508 for thermal management. These heat sinks are strategically positioned within the device 500 to dissipate heat generated by the various components, such as the transceivers and the processor. This thermal management feature ensures that the device 500 operates within safe temperature limits, thereby enhancing the reliability and longevity of the device.

The device 500 also incorporates user interface elements for user interaction. Specifically, the device 500 includes a power button 514 located on one side of the device. The power button 514 allows the user to turn the device 500 on and off, providing a simple and intuitive way for the user to control the operation of the device.

In terms of connectivity, the device 500 includes a SIM socket 532 for cellular connectivity. The SIM socket 532 provides a slot for inserting a SIM card, which enables the device 500 to connect to cellular networks. This feature enhances the versatility of the device 500, allowing it to operate in various network environments and perform network mapping tasks across different types of wireless networks. It will be understood that mapper 500, similar to mapper 100 and 400, may also utilize eSIM technology to increase flexibility.

The device 500 also includes a light pipe 522 for visual feedback. The light pipe 522 is configured to emit light in various colors or patterns to indicate different statuses of the device 500. For example, the light pipe 522 may emit a steady green light to indicate that the device 500 is powered on and operating normally, or it may emit a blinking red light to indicate a network connection error. This visual feedback feature provides the user with an easy and intuitive way to monitor the status of the device 500 and its network connections.

In some aspects, the device 500 may be implemented in a user's mobile device, leveraging the mobile device's hardware augmented with software functionality. This configuration allows the device 500 to take advantage of the existing hardware resources of the mobile device, while adding additional functionality through software. This approach enhances the versatility of the device 500, allowing it to be used in a wide range of devices and environments for network mapping and communication.

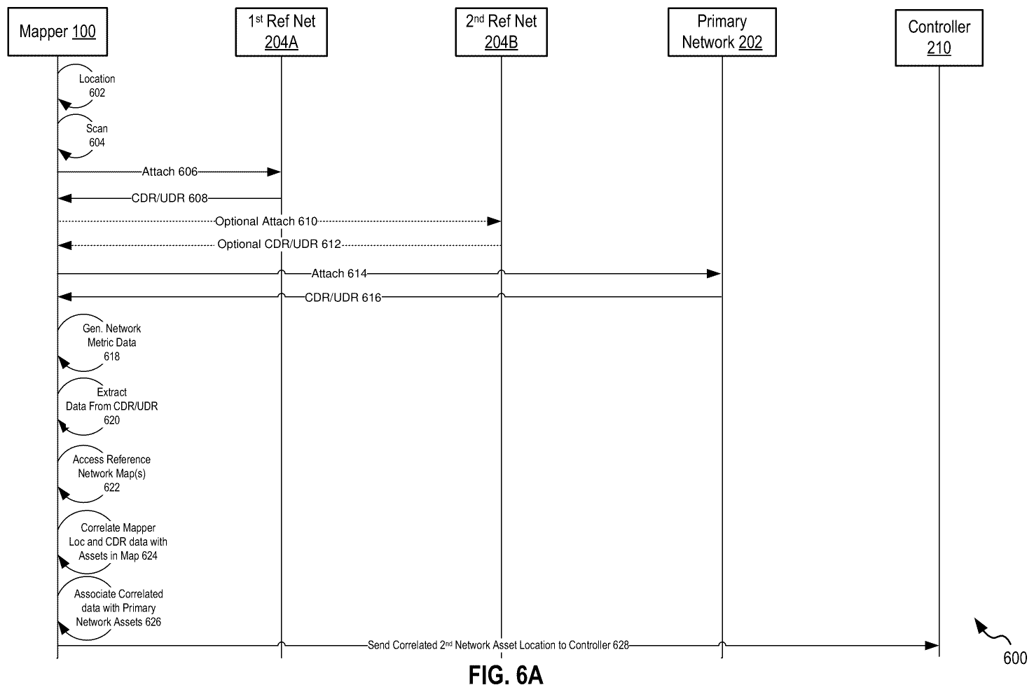

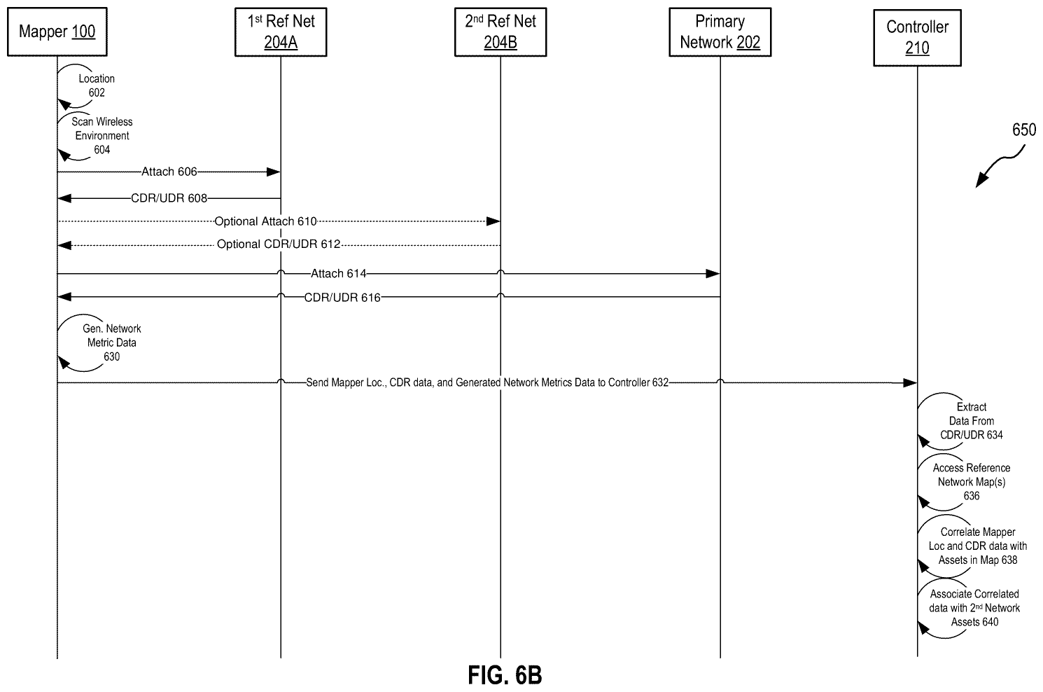

FIG. 6A shows a communication flow 600 for discovering locations of primary network assets using a mapper 100, 500 or system 400. The communication flow 600 begins with the mapper 100 determining its location in step 602 and performing a scan in step 604 of the wireless environment. The mapper 100 then attaches to the first reference network 204A in step 606 and receives a CDR and/or UDR data from it in step 608. The CDR and/or UDR data includes a cell id that uniquely identifies the first reference network 204A asset, later used to locate the network asset.

Optionally, the mapper 100 may also attach to a second reference network 204B in step 610 and receive a second reference network CDR and/or UDR from it in step 612. The second reference network CDR and/or UDR data from second reference network 204B may also include a cell id that uniquely identifies the second reference network 204B asset, later used to locate the network asset.

The mapper 100 then attaches to the primary network 202 in step 614 and receives a primary network CDR and/or UDR from it in step 616. The primary network CDR and/or UDR data from the primary network 202 includes a cell id that uniquely identifies a network cell in the primary network 202. The cell id that uniquely identifies the primary network 202 asset will later be used to tag to the location of the asset. It should be understood that the order of operations of these step may be shifted as needed.

The mapper 100 then processes the CDR and/or UDR data from the first reference network 204A, the optional second reference network 204B, and the primary network 202 to generate network metric data in step 618. The network metric data may include signal quality metrics and RF environment data, which can be processed to derive distance data between the mapper 100 and the network cells in the first reference network 204A, the optional second reference network 204B, and the primary network 202. For example, this data may be used to derive one or both of PNM-to-FRNA distance data and PNM-to-PNA distance data.

The mapper 100 then extracts network data, e.g., cell ID data from CDR data and/or UDR data, to identify the reference network asset and or primary network asset in step 620.

Following this, the mapper 100 accesses reference network maps in step 622 to retrieve known location information for reference network assets identified in step 620. The reference network map includes the locations of the network assets in the first reference network 204A and the optional second reference network 204B. The mapper 100 then correlates its location and CDR and/or UDR data with assets in the map in step 624, using the known locations of reference network assets and distance data derived from the scan step 604 (e.g., PNM-to-FRNA distance data and PNM-to-PNA distance data) and other mapper 100 reference network and primary network signaling to help determine the locations of primary network assets.

The mapper 100 then associates the correlated data with primary network assets in step 626. effectively mapping the locations of these assets based on the correlations established in the previous step.

Finally, in step 628, the mapper 100 sends the correlated primary network asset location data to the controller 210. This step allows the centralized Controller to update its network asset map with the newly discovered, updated, or verified asset locations, potentially improving overall network management and optimization.

This process enables the discovery and mapping of network assets across multiple networks using a single Mapper device, leveraging known reference points to accurately locate and map assets in the primary network.

In some cases, the mapper 100 may utilize additional reference networks to increase the accuracy of determining the location of primary network assets. The mapper 100 may receive CDR data from these additional reference networks and process this data along with the CDR data from the first reference network 204A and the primary network 202 to generate more accurate network metric data.

In some aspects, the mapper 100 may utilize data and measurements derived at different times, at different locations, and or by different mappers to improve the accuracy of determining the location of primary network assets. For example, the mapper 100 may aggregate CDR data and network metric data collected at different times and locations to generate a more comprehensive and accurate network map.

The communication flow 600 for discovering coarse locations of primary network assets as described herein provides a robust and efficient method for wireless network mapping. By leveraging multiple reference networks and processing diverse sets of data, the mapper 100 can accurately determine the locations of primary network assets, thereby enhancing the security, accuracy, and adaptability of the wireless network.

FIG. 6B shows a communication flow 650 for discovering locations of primary network assets using a mapper 100 with partial processing in a cloud or remote processing environment.

Communications flow 650 utilizes the same steps 602-616 as communication flow 600. After step 618, communication flow moves to step 630.

After locating the mapper 100, scanning, attaching, and acquiring CDR data, the mapper 100 generates network metric data in step 630. This data may include various measurements and parameters related to network performance and quality at the Mapper's location. This data can be used to derive mapper to network asset distance data for both the primary network and the reference networks.

The Mapper then sends its location, CDR data, and generated network metrics data to the Controller in step 632. This step allows for centralized processing and analysis of the collected information. Other mappers may also provide data to controller 210, further improving the accuracy of determining the locations of primary network assets.

Upon receiving this information, the Controller extracts data from the CDR/UDR data in step 634. This extraction process may involve parsing the CDR/UDR data to obtain relevant information such as cell IDs. Controller may also access other network data, such as but not limited to signal strength data and timestamps.

In step 636, the Controller accesses reference network maps. These maps may contain known locations of reference network assets and other relevant geographical information. The cell ID data extracted in the prior step may be used to determine the location of the cell ID identified asset on the reference network map.

The Controller then correlates the mapper location, and the determined locations of cell ID identified assets on the reference network in step 638.

Finally, in step 640, the Controller associates the correlated data with primary network assets. This step effectively maps the locations of these primary network assets based on the correlations established in the previous steps and distance data derived from processing signal data and RF environment data associated with at least the connection between the mapper 100 and the primary network asset 202, potentially updating or refining the existing primary network asset map. By using the known location of the mapper, known locations of the reference network assets, and the derived distance data, the primary network assets may be located and that location information can be improved over time with additional location actions.

This process enables the system to discover and locate assets in the primary network by leveraging data from multiple reference networks and the primary network, with the Controller performing the final analysis and mapping tasks.

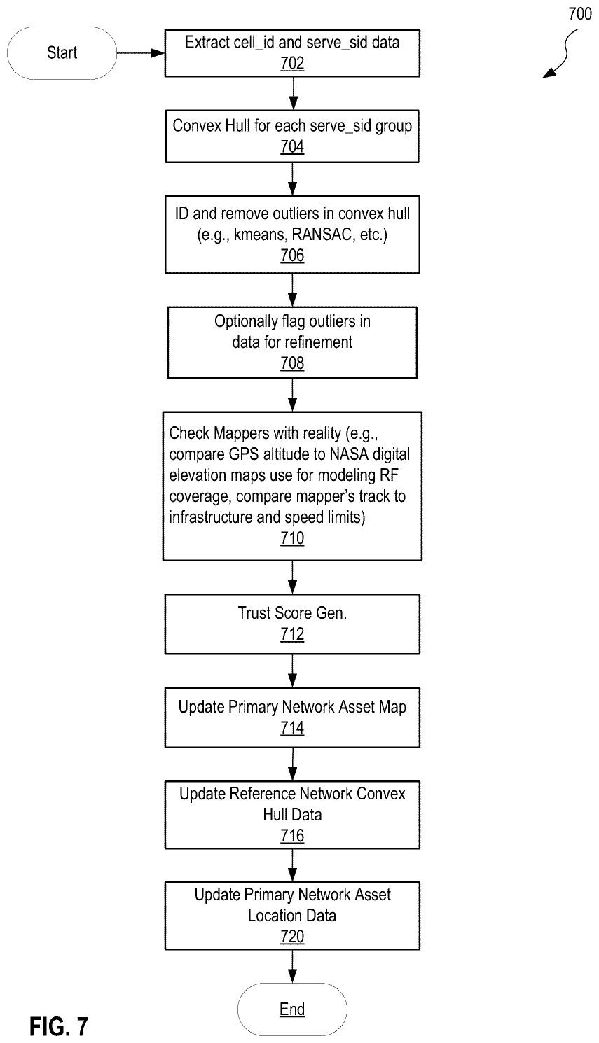

Referring to FIG. 7, the figure illustrates a flowchart for a method 700 of refining and updating a primary network asset map. The method 700 begins with step 702, where cell_id and serve_sid data are extracted. This data provides unique identifiers for network cells and serves as a basis for the subsequent steps of the method.

In step 704, a convex hull is created for each serve_sid group. A convex hull is the smallest convex polygon that contains all the points of the serve_sid group. This step provides a geometric representation of the spatial distribution of the serve_sid groups, which can be used to identify patterns and anomalies in the network asset locations.

Following this, in step 706, outliers in the convex hull are identified and removed using algorithms such as kmeans or RANSAC. Outliers are data points that deviate significantly from the other data points in the same group. These outliers may represent errors or anomalies in the network asset locations, and their removal can improve the accuracy of the network asset map.

In step 708, the method 700 optionally flags outliers in the data for further analysis. This step allows for a more detailed investigation of the outliers, which can provide insights into the causes of the anomalies and help improve the accuracy of the network asset map.

The method 700 then proceeds to step 710, where mappers are checked against reality. This step involves comparing the reported GPS altitude of the mappers to NASA digital elevation maps used for modeling RF coverage. This comparison can help verify the accuracy of the mapper locations and identify discrepancies.

In addition, the method 700 includes comparing the mapper's track to infrastructure and speed limits in step 712. This comparison can help verify the accuracy of the mapper's movement data and identify any anomalies or inconsistencies.

The method 700 next moves to step 714, where the refined and verified data is used to update the primary network asset map. This updated map provides a more accurate representation of the network asset locations, thereby enhancing the reliability and utility of the network mapping process.

Method 700 moves to a first updating step 716, where the convex hull data for the reference networks is updated. Method 700 then updates the primary network asset location data in step 720. This process may repeat to refine both the convex hull coverage data for the reference network, even down to a single cell coverage area, and the location of primary network assets. Repeating method 700 may also be used to monitor and track changes to coverage areas and primary network asset relocations and to detect spoofing.

In some aspects, method 700 may be implemented in a cloud environment, allowing for efficient processing of large amounts of data and providing scalability to accommodate large networks. The cloud environment may also provide robust data storage and backup capabilities, enhancing the reliability of the network mapping process.

In other cases, the method 700 may be implemented at a primary network processing environment. This configuration allows for localized processing of data, which can reduce network latency and improve the responsiveness of the network mapping process. The primary network processing environment may also provide enhanced security features, such as data encryption and access control, to protect the network data from unauthorized access or tampering.

A number of implementations have been described. Nevertheless, it will be understood that various modifications may be made without departing from the spirit and scope of the disclosure. Accordingly, other implementations are within the scope of the following claims.

What is claimed is:

1. A primary network mapper for mapping primary network assets in a primary network, comprising:
a memory storing first reference network asset location data locating one or more first reference network assets in a first reference network;
a first reference transceiver for attachment to and communication with the first reference network;
a primary transceiver for attachment to and communication with the primary network;
a location processor for determining a location of the primary network mapper and generating primary network mapper location data for storage in the memory as primary network mapper location data;
a network metric processor for processing received network data associated with the attachment to one or both of the first reference network and the primary network to derive one or both of a primary network mapper to first reference network asset (PNM-to-FRNA) distance data and primary network mapper to primary network assets (PNM-to-PNA) distance data; and
a primary network asset location processor for determining the location of one or more primary network assets by processing the primary network mapper location data, the first reference network asset location data, the PNM-to-PNA distance data, and the PNM-to-FRNA distance data.

2. The primary network mapper of claim 1, further comprising a hash generator for generating a hash of data derived from one or both of the first reference transceiver and the primary network transceiver.

3. The primary network mapper of claim 1, wherein one or both of the first reference transceiver and primary transceiver are selected from the group consisting of a 3G transceiver, a 4G transceiver, 5G transceiver, a 6G transceiver, Bluetooth transceiver, Bluetooth low energy (BLE) transceiver, Wi-Fi transceiver, LoRa transceiver, an 802.11 transceiver, an 802.16 transceiver, a CBRS transceiver, and an Ultra-Wideband transceiver.

4. The primary network mapper of claim 1, wherein the location processor utilizes a Global Positioning System (GPS) to determine the location of the primary network mapper.

5. The primary network mapper of claim 1, wherein the location processor utilizes one or both of a trilateration process and a triangulation process to determine the location of the primary network asset.

6. The primary network mapper of claim 1, further comprising a third transceiver for scanning, attachment to, and communication with a third wireless network.

7. The primary network mapper of claim 1, wherein the network mapper is capable of scanning the wireless environment to generate radio frequency (RF) environment data.

8. The primary network mapper of claim 1, further comprising a trust score processor for generating and attaching a trust value to one or both of the primary network mapper and data generated by the primary network mapper.

9. The primary network mapper of claim 1, wherein the network mapper receives one or more Call Data Records (CDRs) and/or Usage Detail Records for at least one of the networks it is attached to.

10. The primary network mapper of claim 1, wherein the first reference transceiver and the primary transceiver are the same wireless transceiver.

11. The primary network mapper of claim 1, wherein the first reference transceiver and the primary transceiver are different wireless transceivers.

12. The primary network mapper of claim 11, wherein the first reference transceiver and the primary transceiver utilize the same wireless protocols.

13. The primary network mapper of claim 11, wherein the first reference transceiver and the primary transceiver utilize different wireless protocols.

14. A method for primary network asset location utilizing a network mapper having at least a first reference transceiver and a primary transceiver each utilizing different wireless protocol, comprising:
scanning a wireless environment via the network mapper with the first and the primary transceivers to identify first and primary network attachment points and to generate wireless environment data;
attaching to the first reference network and the primary network to create a wireless communication link;
receiving first reference network asset data and primary network data associated with the first reference network and the primary network;
determining the location of the network mapper utilizing one or more location protocols;
processing one or more of the wireless environment data, the first reference network data, and the primary network data to determine wireless parameters characterizing each of the separate communication links; and
processing the first reference network asset data locating first reference network assets, the wireless parameters, and the location of the network mapper to determine the location of one or more primary network assets.

15. The method of claim 14, further comprising generating a hash of data derived from one or both of the first reference transceiver and the primary transceiver.

16. The method of claim 15, wherein the multiple wireless transceivers are selected from the group consisting of a 4G-LTE transceiver, 5GNR transceiver, a 6G transceiver, Bluetooth transceiver, Bluetooth low energy (BLE) transceiver, Wi-Fi transceiver, LoRa transceiver, an 802.11 transceiver, an 802.16 transceiver, and an Ultra-Wideband transceiver.

17. The method of claim 14, further comprising communicating the location data to a central coordinator via one of the transceivers.

18. The method of claim 14, wherein processing to determine the location of primary network assets is processed in a remote cloud environment.

19. The method of claim 14, wherein processing to determine the location of primary network assets is processed at a primary network processing environment.

20. The method of claim 14, wherein one or both of the first reference network data and the primary network data is at least in part Call Data Record (CDR) data or a Usage Detail Record (UDR).
